(19) United States
(12) Patent Application Publication
(10) Pub. No.: US 2016/0170970 A1
(43) Pub. Date: Jun. 16, 2016

(54) Translation Control

(71) Applicant: Microsoft Technology Licensing, LLC, Redmond, WA (US)

(72) Inventors: Jonas Nils Lindblom, Solna (SE); Steve James Pearce, London (GB); Christian Wendt, Woodinville, WA (US)

(21) Appl. No.: 14/569,343

(22) Filed: Dec. 12, 2014

(51) Int. Cl. G06F 17/28

(52) U.S. Cl. CPC G06F 17/28

(57) ABSTRACT

There is provided an apparatus comprising at least one processor and a memory comprising code that, when executed on the at least one processor, causes the apparatus to receive an input user setting relating to relative volumes of the speech data in a preferred language and speech data in a non-preferred language when the speech data is played-out; and cause play-out of received speech data so that the volume of the played-out speech data is set in dependence on the user input and whether the received speech data is in the preferred language or the non-preferred language.

### BACKGROUND

Speech can be presented to recipients in various applications. For example, communication systems, such as voice-calls, play-out speech to a recipient. As the purpose of these systems is to convey information to a recipient, the speech should be readily understandable to the recipient. However, this is not always the case. For example, the speech may be in a language that is not understood by the recipient. To address this, systems have been developed in which the speech to be played-out is translated into a language understandable to the recipient.

An example of how to do this is explained in relation to a telephone call or the like in which a user (Alice) talks to another user (Bob) in English while Bob only understands Chinese. Alice speaks English into a microphone connected to a transmitter. The transmitter transmits the audio data received via the microphone to a remote server. The remote server transcripts the audio data into written data using a speech-to-text algorithm and detects that the transcripted data is in English. The remote server further determines that Bob would like to hear the data in Chinese. Therefore, the remote server translates the transcripted data into Chinese before turning the Chinese translation into audio data using a text-to-speech conversion algorithm. This translated audio data is then forwarded to Bob and played out via a speaker.

### SUMMARY

The inventors have realised that by only transmitting the translated audio data, important information may be lost, for example, the emotion in the voice of the person speaking, the emphasis in the sentence structure, the identity of the speaker, etc. It would therefore be advantageous to find some way of conveying this emotion to a recipient of translated audio data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to a first aspect, there is disclosed an apparatus comprising at least one processor and a memory comprising code that, when executed on the at least one processor, causes the apparatus to receive an input user setting relating to relative volumes of the speech data in a preferred language and speech data in a non-preferred language when the speech data is played-out; and cause play-out of received speech data so that the volume of the played-out speech data is set in dependence on the user input and whether the received speech data is in the preferred language or the non-preferred language.

According to a second aspect, there is disclosed an apparatus comprising at least one processor; and a memory comprising code that, when executed on the at least one processor, causes the apparatus to: cause play-out of received speech data in a preferred language and received speech data in a non-preferred language simultaneously to a user; determine that speech data in the preferred language and the non-preferred language are being played-out to the user simultaneously; and in response to the determination, automatically adjust the relative volumes of the played-out speech data to output the speech data in the preferred language and the speech data in the non-preferred language to a user at different volumes.

According to a third aspect, there is disclosed a method comprising: receiving an input user setting relating to relative volumes of speech data in a preferred language and speech data in a non-preferred language when speech data is played out; and causing play-out of received speech data so that the volume of the played-out speech data is set in dependence on the user input and whether the received speech data is in the preferred language or the non-preferred language.

### BRIEF DESCRIPTION OF FIGURES

For a better understanding of the subject matter and to show how the same may be carried into effect, reference will now be made by way of example only to the following drawings in which:

FIG. 1 is a schematic illustration of a communication system;

FIG. 2 is a schematic block-diagram of a user device;

FIG. 3 is a schematic block-diagram of a server;

FIG. 4A is a function block diagram showing communication system functionality;

FIG. 4B is a function block diagram showing some of the components of FIG. 4A;

FIG. 5 is a flow chart for a method of facilitating communication between users as part of a call; and

FIG. 6 is an example of a user interface.

### DETAILED DESCRIPTION

The following is directed towards the idea of simultaneously playing-out a speech in the original language in which that speech was recorded and a version of that speech that has been translated into a language other than the original language (“the translated version of the speech”, “translated speech”). In this context, the term simultaneously means that there is an overlap in time during which the speech and the translated speech are both played-out. It does not denote any special correspondence between the information being played-out by the speech and the translated speech at any one time. For example, the translated speech could be delayed relative to the played-out speech to allow time for translation. By playing-out both the speech and its translation simultaneously, the information present in the speech, such as the emotional emphasis in the speech, can be conveyed to a user. In particular, in the following there is provided an apparatus arranged to cause the speech and the translated version of the speech to be played out to a user at different volumes. Such a system is useful in both non-interactive systems (e.g. offline applications in which the translation operation only operates in one direction) and in interactive systems (e.g. a telephone call or video call in which the translation operation operates in multiple directions).

In one example, the apparatus is provided with at least one preferred language of the user currently using that apparatus. All languages that are not indicated as being a preferred language are considered to be non-preferred languages. Thus, whether or not a language is considered to be preferred or not is user-specific and can be configured into a user's settings on the apparatus. The apparatus is arranged to determine whether or not a user has indicated the relative volumes at which the speech in a preferred language and speech in a non-preferred language are to be played out at. For example, the relative volumes at which an original speech and a translated version of that speech are to be played out at. In other words, the recipient of the audio data has some control over the relative volumes. The control may be independent (i.e. the recipient decides the relative volumes entirely by himself) or may be dependent on indications of relative volumes provided by other people receiving similar audio data (e.g. both the sender and the recipient may play out the speech and the translated speech, with the ratio of the volume of the speech to the translated speech being played out by the sender being the inverse of the ratio of the volume of the speech to the translated speech being played out by the receiver). The volume of the preferred language may be set at the maximum the system is currently configured to play out audio from the communication application at whilst the volume of the non-preferred language may be set at a factional level of this maximum (the fraction being less than one). Each device may include an indication of a preferred language (or preferred languages), such that audio data that is determined to be in a preferred language of the user of that device is accorded a larger play-out volume than audio data that is determined to be in a language that is not indicated as being a preferred language of the user of that device.

By using a user setting to determine the relative volume, a user of a play-out device can set the volume of the non-preferred language to be at a level that is not distracting to them. In interactive communication systems relating to the exchange of speech, this technique is applicable to a far side device (i.e. at a device associated with a person currently not speaking, at which the preferred language is not the language of the original speech). The technique is applicable to the near side device (i.e. at the device associated with the speaker, at which the preferred language is the language of the original speech) when that device receives speech originating from the far side device). Further, the near side device may be configured to play-out a received translation of a speech originating from the near side device at a volume level that corresponds to the non-preferred language user setting of the near side device.

The above is now illustrated by way of a specific example. At the near side device a user speaks (or otherwise generates speech data) into a microphone operatively connected to the near side device. This speech is transmitted to a server that generates a translated audio signal of the speech in another language. The translated audio signal and the original speech is transmitted to the far side device. The translated audio signal alone may be transmitted back to the near side device. These transmissions may each include an indication of the language of the speech and an indication of the language of the translated speech in order that the receivers can distinguish between the two. Although it is understood that the translations can be performed locally by at least one receiver (the far side device or near side device) instead of at a server, it can be useful to make this translation at a centralised server, for example, in order to save on processing power at the local devices. When the translation is made by the server, there are two ways in which the resulting audio can be transmitted to a user: The translated speech and the original speech can be transmitted separately in different audio streams. In this case, the relative volume control can be applied directly by the local user device. Alternatively, the translated speech and the original speech can be transmitted in the same audio stream. In this case, the relative volume control can be applied by the server device when mixing the translated speech and the original speech into the same audio stream. If the translated speech and the original speech are transmitted separately, this may increase the amount of signalling in the network, increasing the overhead. However, this approach may allow for a user to have greater control over the relative levels while the audio is being played out (as otherwise the control information would have to be transmitted back to the server for configuration during the mixing stage).

The near side device receives the translated speech and plays-out the translated speech at a default volume level. The default volume level may be a default level set for the play-out of any audio. Alternatively, the default volume level may be a default level set for any speech in a language that is not listed as being a preferred language at that user device.

In contrast, the far side device receives both the speech and the translated speech from the server. In this embodiment, it is assumed that the speech and the translated speech arrive in different audio streams. In this case, the far side device determines from its local user settings that the translated speech, and not the speech, is in a preferred language. By this, it is meant that the user setting on the far side device indicates that the translated speech should be played-out at a higher volume relative to the original speech, as the translated speech is in a preferred language of the far side device. Consequently, at least one speaker at the far side device is arranged to output both the speech and the translated speech to a user such that the translated speech is output at a higher volume than the speech. In both of these cases, the local user setting could specify the degree to which the volumes are relatively different.

Thus there is provided an apparatus configured to receive a speech in a first language, receive a translated version of the speech, receive an input user setting on the apparatus that relates to relative volumes of the speech and the translated speech when the speech and the translated speech are played out and cause the play-out of the speech and the translated speech in dependence on that determined user setting.

More generally, there is provided an apparatus comprising at least one processor and a memory comprising code that, when executed on the at least one processor, causes the apparatus to receive an input user setting relating to relative volumes of the speech data in a preferred language and speech data in a non-preferred language when the speech data is played-out; and cause play-out of received speech data so that the volume of the played-out speech data is set in dependence on the user input and whether the received speech data is in the preferred language or the non-preferred language.

In another example, the apparatus is arranged to determine that the speech data and the translated version of said speech data are being played-out to the user simultaneously. As mentioned above, in this context, the term simultaneously means that there is an overlap in time during which the speech and the translated speech are both played-out. It does not denote any special correspondence between the information being played-out by the speech and the translated speech at any one time. In response to the determination, the apparatus is arranged to automatically adjust the volume of the played-out speech data and the translated speech data to output the two speech data to a user at different volumes. This process allows for an automated method of adjusting the relative volumes of the two speech data to be played out by a user, which does not rely on an external device, such as a server, indicating the relative volume.

For example, we examine the case of a far side receiver. The receiver receives both the speech data and the translated version of the speech data and plays them both out. The receiver can determine that it is playing out both the speech and a translated version of that speech using, for example, an indication received from a centralised server (or wherever the translation entity lies) and/or from an analysis of the different audio data. It is more reliable, however, to rely on an indication from a centralised server regarding the content of the received audio data. In particular, the server may be aware of at least some of the user settings (such as the preferred language) and make a single audio stream for that user in which the speech and the translated speech are combined. After the far side receiver determines that it is playing out both the speech and a translated version of the speech, the receiver automatically applies volume control to the speech and the translated version of the speech such that the translated version of the speech (i.e. in the preferred language in the present example) is played out at a different volume than the original speech.

For obtaining this effect, there is provided an apparatus comprising at least one processor; and a memory comprising code that, when executed on the at least one processor, causes the apparatus to: receive speech data in a first language; receive a version of said speech data translated into a language other than the first language; cause play-out of said speech data to a user simultaneously with said version of said speech data; determine that the speech data and the version of said speech data are being played-out to the user simultaneously; and in response to the determination, automatically adjust the volume of the played-out speech data and the version of said speech data to output the two speech data to a user at different volumes.

More generally, there is provided an apparatus comprising at least one processor; and a memory comprising code that, when executed on the at least one processor, causes the apparatus to: cause play-out of received speech data in a preferred language and received speech data in a non-preferred language simultaneously to a user; determine that speech data in the preferred language and the non-preferred language are being played-out to the user simultaneously; and in response to the determination, automatically adjust the relative volumes of the played-out speech data to output the speech data in the preferred language and the speech data in the non-preferred language to a user at different volumes.

The above described embodiments (i.e. the user setting controlled relative volume and the automatic volume adjustment in response to detecting that the speech and translated speech are being played out) may be combined together so that both operations are performed in the same apparatus. For example, on receiving both the speech and the translated version of the speech, the receiver may cause both the speech and the translated version of the speech to be output to a user. On detecting that the speech and the translated speech are being output, the receiver is configured to cause the speech and the translated speech to be output at different volumes, the different volumes being set in dependence on a local user setting relating to the relative volumes of the two data items. In the event that the speech is received first, without the translated speech, the speech is output at a volume comparable to the volume at which the preferred language is output according to the user settings.

Further, for the above described embodiments and the combination, the techniques may be applied in the user equipment operatively connected to at least one speaker from which the speech and translated speech are to be played out. For example, a user device on the far side may be configured to consult locally cached user settings when causing the play-out of the speech and translated speech. These local user settings may indicate at least one of: whether or not both the speech and the translated speech are to be played out simultaneously; which language(s) are the preferred language(s) of the user currently using the user device; a current maximum volume of any played-out audio; and the relative volume of speech in a preferred language relative to speech not in a preferred language.

A more detailed example will now be described to further illustrate the above principles.

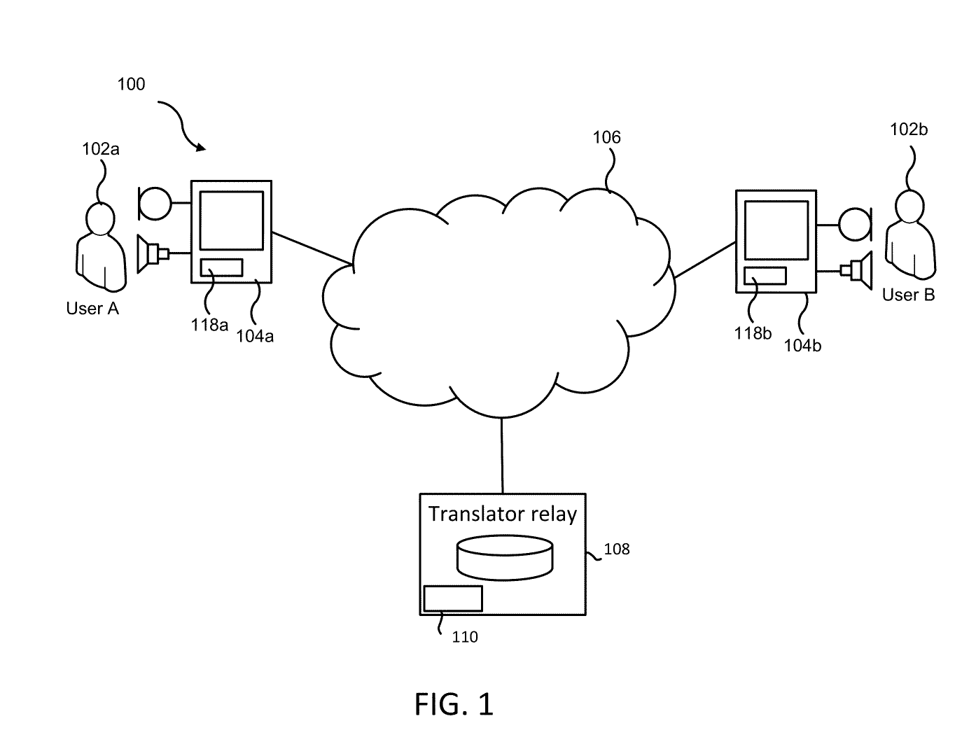

Reference is first made to FIG. 1, which illustrates an interactive communication system 100 which is a packet-based communication system in this embodiment but which may not be packet-based in other embodiments. A first user 102a of the communication system (User A or “Alice”) operates a user device 104a, which is shown connected to a communications network 106. The communications network 106 may for example be the Internet. The user device 104a is arranged to receive information from and output information to the user 102a of the device.

Users may communicate with each other over a communication network e.g. by conducting a call over the network. The network may be, for example, the Internet, any other data communication system, a public landline or mobile system, or any public switched telephone network (PSTN). During a call, audio and/or video signals can be transmitted between nodes of the network, thereby allowing users to transmit and receive audio data (such as speech) and/or video data (such as webcam video) to each other in a communication session over the communication network.

Such communication systems include Voice or Video over Internet protocol (VoIP) systems. To use a VoIP system, a user installs and executes client software on a user device. The client software sets up VoIP connections as well as providing other functions such as registration and user authentication. In addition to voice communication, the client may also set up connections for communication modes, for instance to provide instant messaging (“IM”), SMS messaging, file transfer and voicemail services to users.

The user device 104a is running a communication client 118a, provided by a software provider associated with the communication system 100. The communication client 108a is a software program executed on a local processor in the user device 104a which allows the user device 104a to establish communication events—such as audio calls, audio-and-video calls (equivalently referred to as video calls), instant messaging communication sessions, etc.—over the network 106.

FIG. 1 also shows a second user 102b (User B or “Bob”) who has a user device 104b which executes a client 118b in order to communicate over the network 106 in the same way that the user device 104a executes the client 118a to communicate over the network 106. Therefore users A and B (102a and 102b) can communicate with each other over the communications network 106.

There may be more users connected to the communications network 106, but for clarity only the two users 102a and 102b are shown connected to the network 106 in FIG. 1.

Note that in alternative embodiments, the user devices 104a and/or 104b can connect to the communication network 106 via additional intermediate networks not shown in FIG. 1. For example, if one of the user devices is a particular type of mobile device, then it may connect to the communication network 106 via a cellular mobile network (not shown in FIG. 1), for example a GSM or UMTS network.

Users can have communication client instances running on other devices associated with the same log in/registration details. In the case where the same user, having a particular username, can be simultaneously logged in to multiple instances of the same client application on different devices, a server (or similar) is arranged to map the username (user ID) to all of those multiple instances but also to map a separate sub-identifier (sub-ID) to each particular individual instance. Thus the communication system is capable of distinguishing between the different instances whilst still maintaining a consistent identity for the user within the communication system. Preferably, user settings are associated with a particular user ID in order that they may be migrated across different devices.

User 102a (Alice) is logged-in (authenticated) at client 118a of device 104a as “User 1”. User 102b (Bob) is logged-in (authenticated) at client 118b of device 104b as “User 2”.

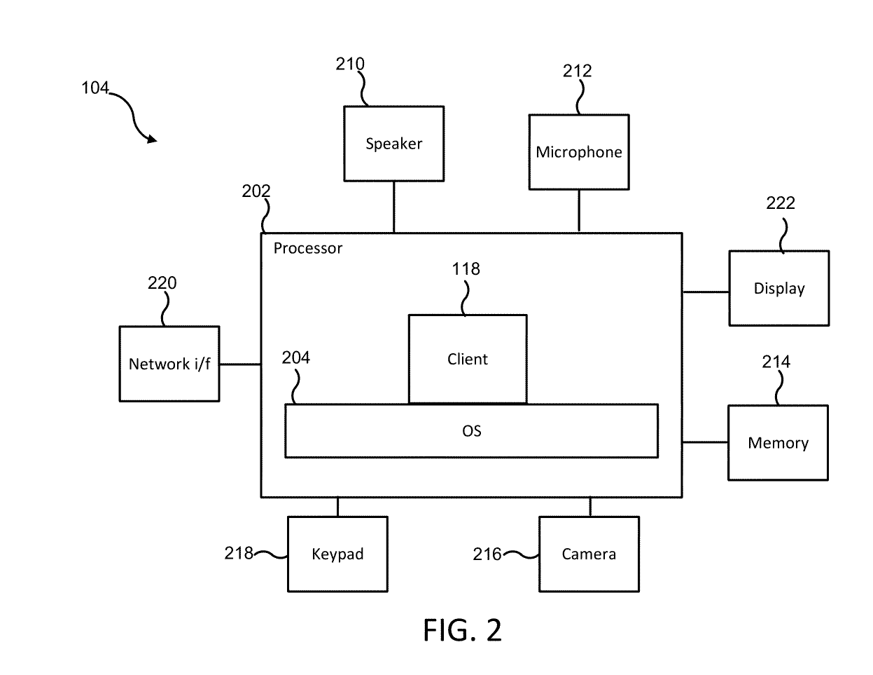

FIG. 2 illustrates a detailed view of a user device 104 (e.g. 104a, 104b) on which is executed a communication client instance 118 (e.g. 118a, 118b). The user device 104 comprises at least one processor 202 in the form of one or more central processing units (“CPUs”), to which is connected a memory (computer storage) 214 for storing data, an output device in the form of a display 222 (e.g. 222a, 222b), having an available display area, such as a display screen, a keypad (or a keyboard) 218 and a camera 216 for capturing video data (which are examples of input devices). The display 222 may comprise a touchscreen for inputting data to the processor 202 and thus also constitute an input device of the user device 104. An output audio device 210 (e.g. one or more loudspeakers) and an input audio device 212 (e.g. one or more microphones) are connected to the CPU 202. The display 222, keypad 218, camera 216, output audio device 210 and input audio device 212 may be integrated into the user device 104, or one or more of the display 222, the keypad 218, the camera 216, the output audio device 210 and the input audio device 212 may not be integrated into the user device 104 and may be connected to the CPU 202 via respective interfaces. One example of such an interface is a USB interface. For example an audio headset (that is, a single device that contains both an output audio component and an input audio component) or headphones//ear buds (or similar) may be connected to a user device via a suitable interface such as USB or audio jack-based interface.

The CPU 202 is connected to a network interface 220 such as a modem for communication with the communications network 106 for communicating over the communication system 100. The network interface 220 may or may not be integrated into the user device 104.

The user device 104 may be, for example, a mobile phone (e.g. smartphone), a personal computer (“PC”) (including, for example, Windows™, Mac OS™ and Linux™ PCs), a gaming device, television (TV) device (e.g. smartTV) tablet computing device or other embedded device able to connect to the network 106.

Some of the components mentioned above may not be present in some user devices e.g. a user device may take the form of a telephone handset (VoIP or otherwise) or telephone conferencing device (VoIP or otherwise).

FIG. 2 also illustrates an operating system (“OS”) 204 executed on the CPU 202. The operating system 204 manages hardware resources of the computer and handles data being transmitted to and from the network via the network interface 220. The client 118 is shown running on top of the OS 204. The client and the OS can be stored in memory 214 for execution on the processor 202.

The client 118 has a user interface (UI) for presenting information to and receiving information from a user of the user device 104. The user interface comprises a graphical user interface (GUI) for displaying information in the available area of the display 222.

Returning to FIG. 1, Alice 102 speaks a source language; Bob speaks a target language other than the source language (i.e. different from the source language) and does not understand the source language (or has only limited understanding thereof). It is thus likely that Bob will be unable to understand, or at least have difficulty in understanding what Alice says in a call between the two users. In the examples below, Bob is presented a Chinese speaker and Alice an English speaker—as will be appreciated this is just one example and the user can speak any two languages of any country or region. Further, “different languages” as used herein is also used to mean different dialects of the same language.

To this end, a language translation relay system (translator relay system) 108 is provided in the communication system 100. The purpose of the translator relay is translating audio in a voice or video call between Alice and Bob. That is, the translator relay is for translating call audio of a voice or video call between Alice and Bob from the source language to the target language to facilitate in-call communication between Alice and Bob (that is, to aid Bob in comprehending Alice during the call and vice versa). The translator relay generates a translation of call audio received from Alice in the source language, the translation being in the target language. The translation may comprise an audible translation encoded as an audio signal for outputting to Bob via the loudspeaker(s) of his device.

The translator relay system 108 acts as both a translator and a relay in the sense that it receives untranslated call audio from Alice via the network 106, translates it, and relays the translated version of Alice's call audio to Bob (that is, transmits the translation directly to Bob via the network 106 for outputting during the call e.g. in contrast to, say, Alice or Bob's user device acting as a requestor by requesting a translation from a translator service, which is returned to the requestor to be passed on to the other device by the requestor itself). This represents a quick and efficient path through the network, which minimizes the burden placed on the clients in terms of network resources and increased the overall speed at which the translation reaches Bob.

The translator performs a “live” automatic translation procedure on a voice or video call between Alice and Bob in the sense that the translation is to some extent synchronous with Alice and Bob's natural speech. For instance, typically natural speech during conversation will involve intervals of speech activity by Alice (that is, intervals in which Alice is speaking interspersed with intervals of speech inactivity by Alice e.g. when Alice pauses for thought or is listening to Bob. An interval of speech activity may e.g. correspond to a sentence or small number of sentences preceded and followed by a pause in Alice's speech. The live translation may be performed per-such interval of speech activity so a translation of Alice's immediately preceding interval of speech activity is triggered by a sufficient (e.g. predetermined) interval of speech inactivity (“immediately preceding” referring to the most recent interval of speech activity that has not already been translated). In this case, as soon as that translation is complete, it may be transmitted to Bob for outputting so that Bob hears it as soon as possible after hearing Alice's most recent period of natural speech activity i.e. so that a period of speech Activity by Alice is heard by Bob, followed by a short pause (while the translation and transmission thereof are performed), followed by Bob hearing the translation of Alice's speech in that interval. Performing translation on a per-such interval basis may result in a higher quality of translation as the translation procedure can make use of the context in which words appear in a sentence to effect a more accurate translation. Because the translator service is acting as a relay, the length of this short pause is minimized resulting in a more natural user experience for Bob.

Alternatively, the automatic translation may be performed on a per-word or per several word basis and e.g. outputted whilst Alice's speech is still ongoing and being heard by Bob e.g. as subtitles displayed on Bob's device and/or as audio played out over the top of Alice's natural speech (e.g. with the volume of Alice's speech reduced relative to the audible translation). This may result in a more responsive user experience for Bob as the translation is generated in near-real-time (e.g. with a less than approx. 2 second response time). The two can also be combined; for instance the intermediate results of the (translated) speech recognition system may be displayed on screen, enabling them to be edited as the best hypothesis changes as the sentence goes on, and the translation of the best hypothesis then translated into audio (see below).

Alternatively, play-out of the source speech may be delayed until a translation of the source speech is available. This would be useful in non-real-time applications.

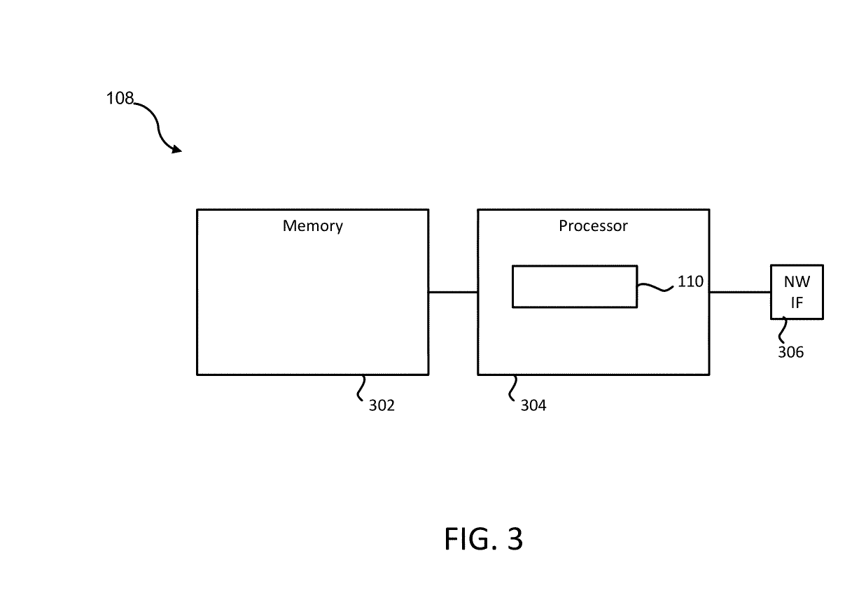

FIG. 3 is a detailed view of a possible translator relay system 108. The translator relay system 108 comprises at least one processor 304, which executes code 110. Connected to the processor 304 are computer storage (memory) 302 for storing the code 110 for said execution and data, and a network interface 306 for connecting to the network 106. Although shown as a single computer device, the functionality of the relay system 108 may alternatively be distributed across multiple computer devices, e.g. multiple servers for instance located in the same datacentre. That is, the functionality of the relay system may be implemented by any computer system comprising one or more computer devices and one or more processors (e.g. one more processor cores). The computer system may be “localized” in the sense that all of the processing and memory functionality is located at substantially the same geographic location (e.g. in the same datacentre comprising one or more locally networked servers, running on the same or different server devices of that datacentre). As will be apparent, this can help to further increase the speed at which the translation is relayed to Bob (which in the example above reduces the length of the short pause between Alice finishing an interval of speech and the commencement of the translation output even further, resulting in an even better user experience for Bob).

As part of the code 110, the memory 302 holds computed code configured to implement a translator agent. As explained in more detail herein, the translator agent is also associated with its own user identifier (user name) within the communication system 100 in the same way that users are associated with corresponding usernames. Thus, the translator agent is also uniquely identified by an associated user identifier and thereby appears, in some embodiments, as another user of the communication system 100, for instance appearing to be constantly an online user which ‘real’ users 104a, 104b can add as a contact and transmit data to/receive data from using their respective clients 118a, 118b; in other embodiments, the fact that a bot having a user identifier may be hidden (or at least disguised so as to be substantially hidden) to the users e.g. with the client UIs configured such that the users would be unaware of bot identities (discussed below).

As will be appreciated, multiple bots can share the same identity (that is, be associated with the same username) and those bots can be distinguished using different identifiers which may be invisible to end-users.

The translator relay system 108 may also perform other functions which are not necessarily directly related to translation such as mixing of call audio streams as in example embodiments described below.

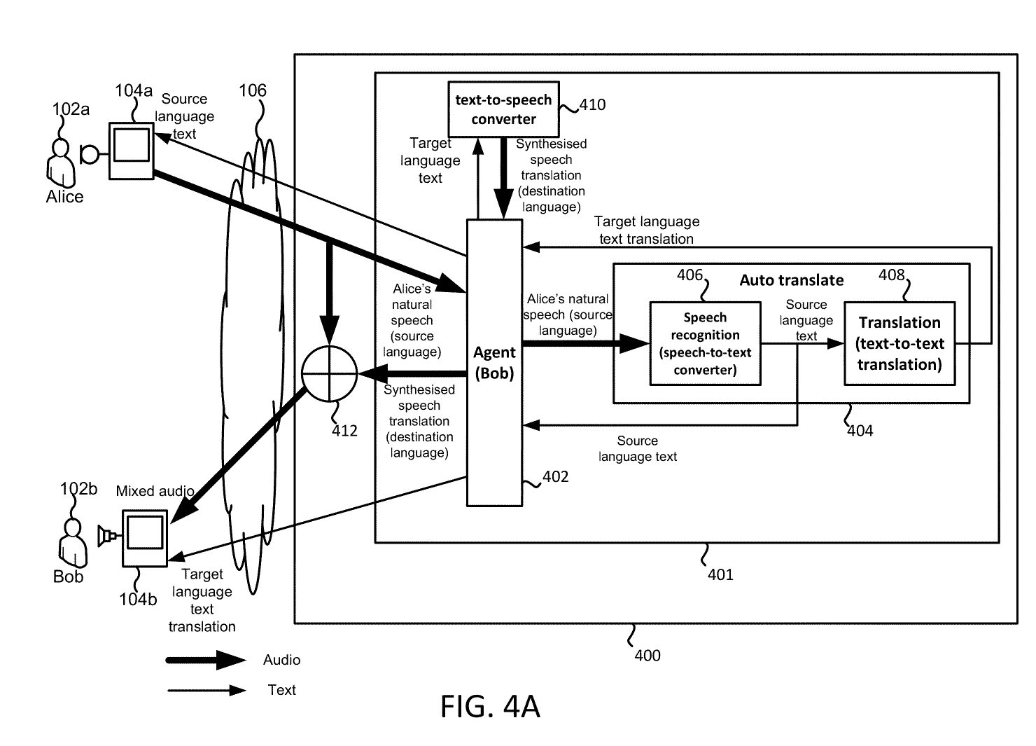

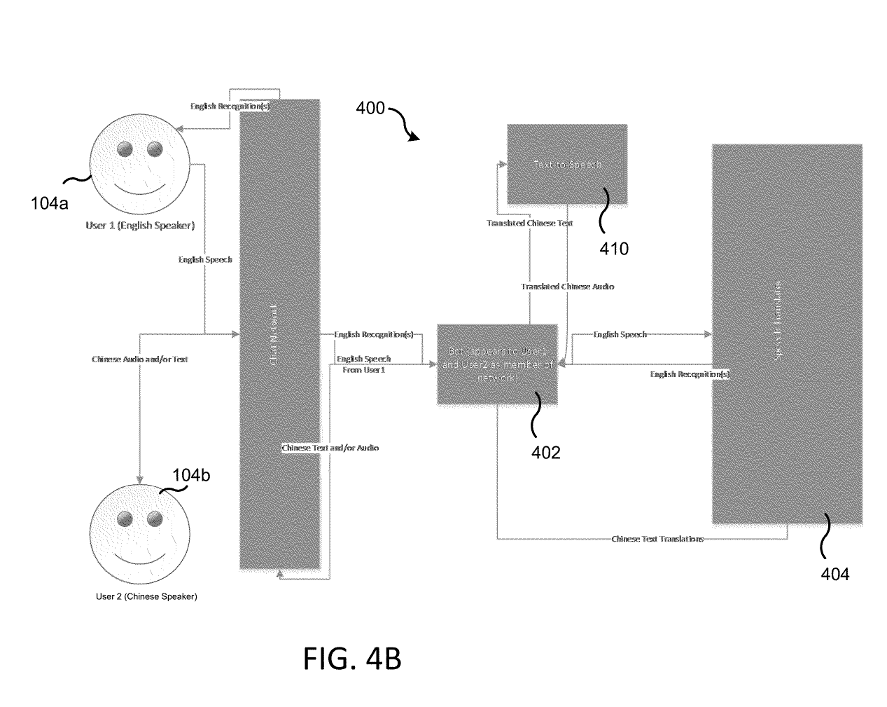

FIG. 4A is a function block diagram illustrating interactions and signalling between the user devices 104a, 104b and a call management component 400. In accordance with the various methods described herein, the call management system 400 facilitates interpersonal communication between people who do not share a common language (e.g. Alice and Bob). FIG. 4B is another illustration of some of the components shown in FIG. 4A.

The call management component 400 represents functionality implemented by executing the code 110 on the translator relay system 108. The call management component is shown comprising functional blocks (components) 402-412 which represent different functions performed by said code 110 when executed. Specifically, the call managements component 400 comprises the following components: an instance 402 of the aforementioned translator agent whose functionality is described in more detail herein, an audio translator 404 configured to translate audio speech in the source language into text in the target language, a text-to-speech converter 410 configured to convert text in the destination language to synthesised speech in the destination language, and an audio mixer 412 configured to mix multiple input audio signals to generate a single mixed audio stream comprising audio from each of those signals. The audio translator comprises an automatic speech recognition component 406 configured for the source language. That is, configured for recognizing the source language in received audio i.e. for identifying that particular portions of sound correspond to words in the source language (specifically to convert the audio speech in the source language into text in the source language in this embodiment; in other embodiments, it need not be text—for instance, the translator may translate a full set of hypotheses provided by the speech engine, represented as a lattice, which could be encoded in various ways). The speech recognition may also be configured to identify which language is being spoken on-the-fly (and configured for the source language in response e.g. configured to a ‘French-to- . . . ’ mode in response to detecting French), or it may be preconfigured for the source language (e.g. via a UI or profile setting, or by instant messaging-based signalling etc. which preconfigures the bot to, say, a ‘French-to- . . . ’ mode) The component 400 also comprises a text translator 408 configured to translate text in the source language into text in the target language. Collectively components 404, 408 implement the translation functionality of the audio translator 404. The components 402, 404 and 410 constitute a back-end translation subsystem (translation service) 401, with the components 404 and 410 constituting a speech-to-speech translation (S2ST) subsystem thereof and the agent operating as an intermediary between the clients 118a/118b and that subsystem.

As indicated, the components of FIG. 4A/4B may represent processes running on the same machine or distinct processes running on different machines (e.g. the speech recognition and text translation may be implemented as two distinct processes running on different machines).

The translator agent has a first input connected to receive call audio from Alice's user device 104a via the network 106, a first output connected to an input of the audio translator 404 (specifically, of the speech recognition component 406), a second input connected to an output of the speech recognition component 406 (which is a first output of the audio translator 404), a third input connected to an output of the text translator 408 (which is a second output of the audio translator 404), a second output connected to a first input of the mixer 412, a third output connected to transmit translated text in the target language to Bob's user device 104b, and a fourth output configured to transmit recognized text in the source language to both Alice's user device 104a and also to Bob's user device 104b. The agent 402 also has a fourth input connected to an output of the text-to-speech converter 410 and a fifth output connected to an input of the text-to-speech converter. The mixer 412 has a second input connected to receive the call audio from Alice's device 104a and an output connected to transmit the mixed audio stream to Bob via the network 106. The output of the speech recognition component 406 is also connected to an input of the text translator 408. Inputs/outputs representing audio signals are shown as thick solid arrows in FIG. 4A; inputs/outputs representing text-based signals are shown as thin arrows.

The translator agent instance 402 functions as an interface between Alice and Bob's clients 118 and the translation subsystem 401 and operates as an independent “software agent”. Agent-based computing is known in the art. A software agent is an autonomous computer program that carries out tasks on behalf of users in a relationship of agency. In acting as a software agent, the translator agent 402 functions as an autonomous software entity which, once initiated (e.g. responsive to an initiation of a call or related session) runs substantially continuously over the duration of that specific call or session (as opposed to being executed on demand; that is as opposed to being executed only when required to perform some specific task), awaiting inputs which, when detected, trigger automated tasks to be performed on those inputs by the translator agent 402.

In particular embodiments, the translator agent instance 402 has an identity within the communication system 100 just as users of the system 100 have identities within the system. In this sense, the translator agent can be considered a “bot”; that is an artificial intelligence (AI) software entity that appears as a regular user (member) of the communication system 100 by virtue of its associated username and behaviour (see above). In some implementations, a different respective instance of a bot may be assigned to each call (i.e. on an instance-per-call basis), e.g. EnglishChineseTranslator1, EnglishChineseTranslator2. That is, in some implementations the bot is associated to a single session (e.g. call between two or more users). On the other hand, the translation service to which the bot provides an interface may be shared among multiple bots (and also other clients).

In other implementations, a Bot instance that is able to carry on multiple conversations at the same time could be configured in a straightforward manner.

In particular, human users 104a, 104b of the communication system 100 can include the bot as a participant in voice or video calls between two or more human users e.g. by inviting the bot to join an established call as a participant, or by requesting that the bot initiate a multiparty call between the desired two or more human participants and the bot itself. The request is instigated by the client user interface of one of the client 118a, 118b, which provides options for selecting the bot and any desired human users as call participants e.g. by listing the humans and the bots as contacts in a contact list displayed via the client user interface.

Bot-based embodiments do not require specialized hardware devices or specialized software to be installed on users' machines and/or require the speakers (that is, participants) to be physically close to each other as the bot can be seamlessly integrated into existing communication system architecture without the need to e.g. redistributed updated software clients.

At the top level, the “bot” appears to users of the chat system just as a regular human network member would. The bot intercepts audio stream(s) from all the users who speak its source language (e.g. 104a), and passes them on to a speech-to-text translation system (audio translator 404). The output of the speech-to-text translation system is target language text. The bot then communicates the target language information to the target language user(s) 104b. The bot may also communicate the speech recognition results of the source audio signal to the source speaker 104a and/or the target listener 104b. The source speaker can then correct the recognition results by feeding back correction information to the bot via the network 106 in order to get a better translation, or try repeating or restating their utterance (or portions thereof) in order to achieve better recognition and translation. The implementation details of the bot depend on the architecture of and level of access to the chat network.

Implementations for systems providing SDK's (“Software Developer Kits”) will depend on the features provided by the SDK. Typically these will provide read access to separate video and audio streams for each conversation participant, and write access to the video and audio streams for the bot itself.

Some systems provide server-side Bot SDK's, which allow full access to all streams and enable scenarios such as imposing video subtitles over the source speaker's video signal and/or replacing or mixing the source speaker's audio output signal. Finally, where complete control over the system is available, translation can be integrated in any manner, including changes to client UI in order to make the inter-lingual conversation experience easier for the users.

Translation can either be turn-based (the Bot waits until the user pauses or indicates in some other way that their utterance is complete, like, say, clicking button, then communicates the target language information) or simultaneous—that is, substantially contemporaneous with the source speech (the Bot begins to communicate the target language information the moment it has enough text to produce semantically and syntactically coherent output). The former uses Voice Activation Detection to determine when to commence translating a preceding portion of speech (translation being per interval of detected speech activity); the latter uses voice activation detection and an automatic segmentation component (being performed, for each interval of detected speech activity, on a per segment of that interval, which may have one or more segments). As will be appreciated, components for performing such functions are readily available. In the turn-based scenario the use of a bot acting as a third party virtual translator in the call would aid the users by framing them in a common real world scenario with a translator (such as one might have in a courtroom); simultaneous translation is analogous to a human simultaneous interpreter (e.g. such as one encounters in the European Parliament or the UN). Thus, both provide an intuitive translation experience for Bob and other potential recipients.

It should be noted that references to “automated translation” (or similar) as used herein cover both turn-based and simultaneous translation (among others). That is, “automated translation” (or similar) covers both the automated emulation of human translators and human interpreters.

As will be appreciated, the subject matter is not restricted to any particular speech recognition or translation components—for all intents and purposes, these can be treated as a black box. Techniques for rendering a translation from a speech signal are known in the art, and there are numerous components available to perform such functions.

Although FIGS. 4A/4B show only a one-way translation for the sake of simplicity, it will be readily appreciated that the bot 402 can perform equivalent translation functions on Bob's call audio for the benefit of Alice. Similarly, whilst methods below are described in relation to one-way translation for simplicity, it will be appreciated that such methods can be applied to two-way (or multi-way) translation.

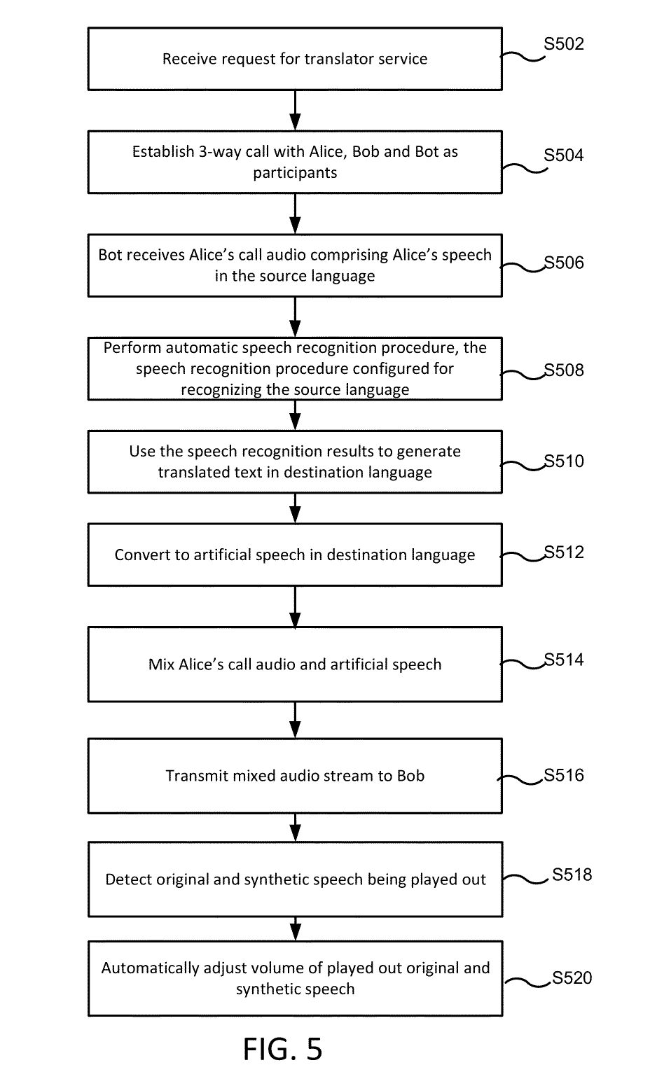

A method of facilitating communication between users during a voice or video call between those users will now be described with reference to FIG. 5, which is a flow chart for the method. FIG. 5 describes an in-call translation procedure from Alice's language to Bob's language only for simplicity; it will be appreciated that a separate and equivalent process can be performed to translate from Bob's language to Alice's language simultaneously in the same call (from which perspective, Alice could be viewed as the target and Bob as the source). Further, the following example takes the case where the source speech and the translated speech are sent to a receiver (Bob) in separate audio streams. However, it is understood that the source speech and the translated speech may instead be mixed together into a single audio stream at a server/translation agent. In this latter case, the different audio levels may be set by the server. For example, a user-specific audio stream (intended for unicast transmission) may be generated that sets the relative volumes of the source speech and the translated speech according to a user's specific user settings. Thus, for this purpose, the user settings may be accessible to a server and may even be uploaded onto the server.

At step S502, a request for a translator service is received by the translator relay system 108, requesting that the bot perform a translation service during a voice or video call in which Alice, Bob and the bot will be participants. The call thus constitutes a multiparty (group)—specifically three-way—call. At step S504, the call is established. The request may be a request for the agent 402 to establish a multiparty call between the bot 402 and at least Alice and Bob in which case the bot establishes the call (with S502 thus being before S504) by instigating call invitations to Alice and Bob, or the request may be an invitation for the bot 402 to join an already-established call between at least Alice and Bob (with S504 thus being after S502) in which case Alice (or Bob) establishes the call by instigating call invitations to Bob (or Alice) and the bot). It may be instigated via the client UI or automatically either by the client or some other entity (e.g. a calendar service configured to automatically instigate a call at a pre-specified time).

At step S506, the bot 402 receives Alice's call audio as an audio stream via network 106 from Alice's client 118a. The call audio is audio captured by Alice's microphone, and comprises Alice's speech which is in the source language. The bot 402 supplies the call audio to the speech recognition component 406.

At step S508, the speech recognition component 406 performs a speech recognition procedure on the call audio. The speech recognition procedure is configured for recognizing the source language. Specifically, the speech recognition procedure detects particular patterns in the call audio which it matches to known speech patterns of the source language in order to generate an alternative representation of that speech. The results of the speech recognition procedure (e.g. string/feature vectors) are supplied back to the bot 402.

At step S510, the speech translator 408 performs a translation procedure on the input results into text in the target language (or some other similar representation). The translation is performed ‘substantially-live e.g. on a per-sentence (or few sentences), per detected segment, or per-word (or few words) basis as mentioned above. Thus, translated text is outputted semi-continuously as call audio is still being received from Alice. The target language text is supplied back to the bot 402.

At step S512, the target language text is supplied by the bot to the text-to-speech converter, which converts the target language text into artificial speech spoken in the target language. The synthetic speech is supplied back to the bot 402.

Because both the text output from the audio translator 404 and the synthetic speech are in the target language, they are comprehensible to Bob who speaks the target language.

At step S514, the synthetic translated speech in the target language and the original natural speech in the source language is transmitted to Bob via the network 106 (S516) for outputting via the audio output device(s) of his user device as part of the call. One audio stream is provided for the synthetic translated speech in the target language and another (different) audio stream is provided for the original natural speech in the source language.

At step S518, Bob's device detects that both the original and synthetic audio are being played out simultaneously. In response to this detection, at S520 Bob's device automatically adjusts the volume of the played-out original and synthetic audio so that they are transmitted at different volumes to each other. The volume is adjusted in dependence on a user setting associated with Bob's account, which indicates a preferred language for receiving audio data. In particular, if one of the received original and synthetic audio is in the preferred language, this is output at a higher volume than any received audio that is not in the preferred language. The ratio of the volume of the received audio is determined in relation to a user setting, which has been input by a user. This user setting of the ratio of the volume of preferred-language-audio to non-preferred-language-audio may be varied during play-out of the audio. Alternatively, the devices may be configured to only allow a user to provide an input setting the ratio before translation begins.

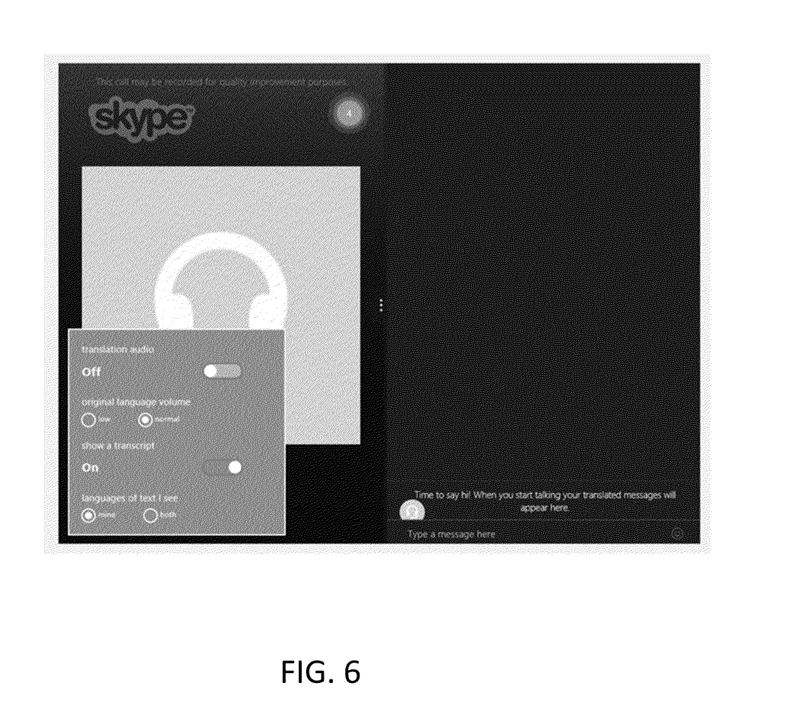

A potential user interface 600 suitable for displaying information to a user during operation of the above described system is shown in FIG. 6. The user interface is divided into 2 sides. On the left hand side 601, there is the logo of the company 602, an avatar representative of the user and the user settings box 604. The user settings box is currently in a maximised form: a smaller icon that links through to this maximised form may be provided. The avatar may be a still image or be a video stream or gif. The user settings box comprises a number of different settings. For example, a setting 604a that indicates whether or not the translated speech is to be played out, a setting 604b that indicates a volume setting for playing-out the original language speech data, a setting 604c that indicates whether or not a transcript of the voice or video call should be provided and a setting 604d that indicates whether if only a transcript in the translated language should be provided or if transcripts in both the original and translated languages should be provided. On the right hand side 605 of the interface, there is an area for the transcripts to be displayed.

As mentioned above, in some embodiments the mixer 412 of FIG. 4A is implemented by the relay system 108 itself. That is, as well as implementing translator functions, the relay system 108 also implements call audio mixing functions. Implementing mixing functionality (whereby, for each human participant, multiple individual audio streams are mixed into a single respective audio stream to be transmitted to that user) at the relay system 108 itself rather than elsewhere in the system (e.g. at one of the user devices 104a, 104) provides convenient access to the individual audio streams to the Bot—as mentioned above, having access to the individual call audio streams can result in a better quality of translation. Where the relay system 108 is also localized, this also ensures that the bot has immediate, fast access to the individual audio streams which further minimizes any translation delays.

Where additional users participate in a call (in addition to Alice, Bob and the bot itself), call audio streams from these users may also, with separate translations being performed on each audio stream by the bot 402. Where more than two human users participate in a call, the audio streams for all those users may be individually received at the relay system 108 for mixing thereat, thereby also providing convenient access to all those individual audio streams for use by the bot. Each user may then receive a mixed audio stream containing all the necessary translations (i.e. synthetic translated speech for each user speaking a different language to that user). A system with three (or more) users could have each user speaking a different language, where their speech would be translated into both (or more) target languages, and the speech from both (or more) target speakers would be translated into their language. Each user may be presented via their client UIs with the original text and their own translation. For example, User A speaks English, user B Italian and User C French. User A speaks and user B will hear English and Italian, whereas User C will hear English and French.

In some exiting communication systems, the user who initiates a group call is automatically assigned to host that call, with call audio being mixed at that user's device by default and other clients in the call automatically sending their audio streams to that user by default for mixing. The host is expected to then generate a respective mixed audio stream for each user, the respective audio stream for that user being a mix of all the other participants' audio (i.e. all audio other than that user's own audio). In such systems, a request for the bot to initiate the call will ensure that the bot is assigned as host, thereby ensuring that each other participant's client transmits their individual audio stream to the relay system 108 for mixing thereat by default thus granting access to the individual audio streams to the bot by default. The bot then provides a respective mixed audio stream to each participant which not only includes the audio of the other human participants but also any audio (e.g. synthesised translated speech) to be conveyed by the bot itself.

In some bot-based implementations, the client software may be modified (in particular the client graphical user interface may be modified) to disguise the fact that a bot is performing the translation. That is, from the perspective of the underlying architecture of the communication system, the bot appears substantially as if they were another member of the communication system to enable the bot to be seamlessly integrated into that communication system without modification to the underlying architecture; however this may be hidden from users so that the fact that any in-call translations which they are receiving are being conveyed by a bot who is a participant in the call (at least in terms of the underlying protocols) is substantially invisible at the user interface level.

Whilst the above is described with reference to a bot implementation—that is, with reference to a translator agent that is integrated into the communication system 100 by associating that agent with its own user identifier such that it appears as a regular user of the communication system 100—other embodiments may not be bot implemented. For instance, the translator relay 108 may instead be integrated into a communication system as part of the architecture of the communication system itself, with communication between the system 108 and the various clients being effected by bespoke communication protocols tailored to such interactions. For example, the translator agent may be hosted in a cloud as a cloud service (e.g. running on one or more virtual machines implemented by an underlying cloud hardware platform).

That is, the translator could e.g. be a computer device/system of such devices running a bot with a user identifier, or a translator service running in the cloud etc. Either way, call audio is received from Alice, but the translation is sent directly to the Bob from the translator system (not relayed through the Alice's client) i.e. in each case, the translator system acts as an effective relay between the source and Bob and/or any other recipients of the speech data and the translated speech data. A cloud (or similar) service could for instance be accessed from directly from a web browser (e.g. by downloading a plugin or using plugin-free in-browser communication e.g. based on JavaScript), from a dedicated software client (application or embedded), by dialing in from a regular telephone or mobile etc.

It should be noted that although the term “played out to a user” is used, it is understood that there may or may not be a user present to listen to the played out audio data. This term is merely meant to convey that the mentioned audio data is output via at least one speaker.

It should be noted that where references are made in the above to a server, this is intended to convey a physical apparatus associated with a bot, as described above. In some cases, the bot may be resident local to one of the user devices that a user uses for communications, as per the above described embodiments. Thus the term server may, in the present application, refer to the user device itself. The term may also be used to refer to a processing apparatus located remotely to the user devices that a user interfaces with for communication with another user.

Thus there is provided an apparatus comprising: at least one processor; and a memory comprising code that, when executed on the at least one processor, causes the apparatus to: receive an input user setting relating to relative volumes of speech data in a preferred language and speech data in a non-preferred language when speech data is played-out; and cause play-out of received speech data so that the volume of the played-out speech data is set in dependence on the user input and whether the received speech data is in the preferred language or the non-preferred language.

The memory may further comprise code that, when executed on the at least one processor, causes the apparatus to: determine that the received speech data being played-out to the user comprises speech data in the preferred language and speech data in the non-preferred language; and in response to the determination, automatically adjust the volume of the played-out speech data to output the speech data in the preferred language and the speech data in the non-preferred language to a user at different volumes.

There is also provided an apparatus comprising: at least one processor; and a memory comprising code that, when executed on the at least one processor, causes the apparatus to: cause play-out of received speech data in a preferred language and received speech data in a non-preferred language to a user simultaneously; determine that speech data in the preferred language and speech data in the non-preferred language are being played-out to the user simultaneously; and in response to the determination, automatically adjust the volumes of the played-out speech data to output the speech data in the preferred language and the speech data in the non-preferred language to a user at different volumes.

The memory may further comprise code that, when executed on the at least one processor, causes the apparatus to: receive an user setting on the apparatus relating to relative volumes of speech data in a preferred language and speech data in a non-preferred language when speech data is played-out; wherein the adjustment to the volume of the played-out speech data to output the speech data in the preferred language and the speech data in the non-preferred language to a user at different volumes is dependent on the user setting.

The following applies to both of the above mentioned apparatus.

The apparatus may be a user device operatively connected to at least one speaker, and wherein the play-out of the speech data is effected through the at least one speaker. The memory may further comprises code that, when executed on the at least one processor, causes the apparatus to: cause play-out the speech data in the preferred language at a higher volume than the speech data in the non-preferred language.

The speech data in the preferred language and the speech data in the non-preferred language may be received in the same audio stream.

The apparatus may be a server located remotely from a source of the speech data, and wherein the memory further comprises code that, when executed on the at least one processor, causes the apparatus to: receive an indication of a preferred language of a recipient of the speech data; and cause the speech data to be translated into the preferred language, thereby forming the speech data in the preferred language. The memory may further comprise code that, when executed on the at least one processor, causes the apparatus to: transmit at least the translated speech data to an originator of the speech data with an indication of the language of the translated speech data. The memory may further comprise code that, when executed on the at least one processor, causes the apparatus to: transmit to said recipient the translated speech data with an indication of the language of the translated speech data; and transmit to said recipient the speech data with an indication of the language of the speech data.

The speech data may be real-time audio data originating during a voice call and/or a video call.

There is also provided a method comprising: receiving an input user setting relating to relative volumes of speech data speech data in a non-preferred language when speech data is played out; and causing play-out of received speech data so that the volume of the speech data is set in dependence on the user input and whether the received speech data is in the preferred language or in the non-preferred language.

The method may further comprise: determining that received speech data being played-out to the user comprises speech data in the preferred language and speech data in the non-preferred language; and in response to the determining, automatically adjusting the volume of the played-out speech data in the preferred language and the speech data in the non-preferred language to a user at different volumes.

The method may further comprise effectuating the play-out of the speech data through at least one speaker.

The method may further comprise: causing play-out the speech data in the preferred language at a higher volume than the speech data in the non-preferred language.

The method may further comprising: receiving speech data from a microphone operatively connected to the apparatus; and transmitting the speech data to a remote server; receiving a translation of the speech data in a non-preferred language from the remote server; and causing play-out of the received speech data at a volume associated with the non-preferred language.

The method may further comprise: receiving an indication of a preferred language of a recipient of the speech data; and causing the speech data to be translated into the preferred language, thereby forming the speech data in the non-preferred language.

The method may further comprise: transmitting at least the translated speech data to an originator of the received speech data with an indication of the language of the translated speech data.

The speech data and the translated speech data may be received in the same audio stream.

The speech data may be real-time audio data originating during a voice call and/or a video call.

1. An apparatus comprising:
at least one processor; and
a memory comprising code that, when executed on the at least one processor, causes the apparatus to:
receive an input user setting relating to relative volumes of speech data in a preferred language and speech data in a non-preferred language when speech data is played out; and
cause play-out of received speech data so that the volume of the played-out speech data is set in dependence on the user input and whether the received speech data is in the preferred language or the non-preferred language.

2. An apparatus as claimed in claim 1, wherein the memory further comprises code that, when executed on the at least one processor, causes the apparatus to:
determine that received speech data being played-out to the user comprises speech data in the preferred language and speech data in the non-preferred language; and
in response to the determination, automatically adjust the volume of the played-out speech data to output the speech data in the preferred language and the speech data in the non-preferred language to a user at different volumes.

3. An apparatus comprising:
at least one processor; and
a memory comprising code that, when executed on the at least one processor, causes the apparatus to:
cause play-out of received speech data in a preferred language and received speech data in a non-preferred language to a user simultaneously;
determine that speech data in the preferred language and the speech data in the non-preferred language are being played-out to the user simultaneously; and
in response to the determination, automatically adjust the relative volumes of the played-out speech data to output the speech data in the preferred language and the speech data in the non-preferred language to a user at different volumes.

4. An apparatus as claimed in claim 3, wherein the memory further comprises code that, when executed on the at least one processor, causes the apparatus to:
receive an input user setting on the apparatus relating to relative volumes of speech data in a preferred language and speech data in a non-preferred when speech data is played out;
wherein the adjustment to the volume of the played-out speech data to output the speech data in the preferred language and the speech data in the non-preferred language to a user at different volumes is dependent on the user setting.

5. An apparatus as claimed in claim 1, wherein the apparatus is a user device operatively connected to at least one speaker, and wherein the play-out of the speech data is effected through the at least one speaker.

6. An apparatus as claimed in claim 5 when dependent on any of claim 1, wherein the memory further comprises code that, when executed on the at least one processor, causes the apparatus to:
cause play-out the speech data in the preferred language at a higher volume than the speech data in the non-preferred language.

7. An apparatus as claimed in claim 1, wherein the memory further comprises code that, when executed on the at least one processor, causes the apparatus to: receive speech data in the preferred language and speech data in the non-preferred language in the same audio stream.

8. An apparatus as claimed in claim 1, wherein the apparatus is a server located remotely from a source of the speech data, and wherein the memory further comprises code that, when executed on the at least one processor, causes the apparatus to:
receive an indication of a preferred language of a recipient of the speech data; and
cause the speech data to be translated into the preferred language, thereby forming the speech data in a preferred language.

9. An apparatus as claimed in claim 8, wherein the memory further comprises code that, when executed on the at least one processor, causes the apparatus to:
transmit at least the translated speech data to an originator of the speech data with an indication of the language of the translated speech data.

10. An apparatus as claimed in claim 8, wherein the memory further comprises code that, when executed on the at least one processor, causes the apparatus to:
transmit to said recipient the translated speech data with an indication of the language of the translated speech data; and
transmit to said recipient the speech data with an indication of the language of the speech data.

11. An apparatus as claimed in claim 1, wherein the speech data is real-time audio data originating during a voice call and/or a video call.

12. A method comprising:
receiving an input user setting relating to relative volumes of speech data in a preferred language and speech data in a non-preferred language when speech data is played out; and
causing play-out of received speech data so that the volume of the played-out speech data is set in dependence on the user input and whether the received speech data is in the preferred language or the non-preferred language.

13. A method as claimed in claim 12, further comprising:
determining that received speech data being played-out to the user comprises speech data in a preferred language and speech data in a non-preferred language; and
in response to the determining, automatically adjusting the volume of the played-out speech data to output the speech data in the preferred language and the speech data in the non-preferred language to a user at different volumes.

14. A method as claimed in claim 12, further comprising effectuating the play-out of the speech data through at least one speaker.

15. A method as claimed in claim 12, further comprising:
causing play-out the speech data in the preferred language at a higher volume than the speech data in the non-preferred language.

16. A method as claimed in claim 12, further comprising:
receiving speech data from a microphone operatively connected to the apparatus;
transmitting the speech data to a remote server;
receiving a translation of the speech data in a non-preferred language from the remote server; and
causing play-out the received speech data at a volume associated with the non-preferred language.

17. A method as claimed in claim 12, further comprising:
receiving an indication of a preferred language of a recipient of the speech data; and
causing the speech data to be translated into the preferred language, thereby forming the speech data in a preferred language.

18. A method as claimed in claim 17, further comprising:
transmitting at least the translated speech data to an originator of the received speech data with an indication of the language of the translated speech data.

19. A method as claimed in claim 18, wherein the speech data and the translated speech data are received in the same audio stream.

20. A method as claimed in claim 12, wherein the speech data is real-time audio data originating during a voice call and/or a video conference.
